(19) United States
(12) Patent Application Publication
(10) Pub. No.: US 2025/0233181 A1
(43) Pub. Date: Jul. 17, 2025

(54) METHOD AND DEVICE FOR PRODUCING MEMBRANE ASSEMBLIES

(71) Applicant: OPTIMA life science GmbH, Schwäbisch Hall (DE)

(72) Inventors: Norbert Dylla, Vellberg (DE); Johannes Jansen, Michelfeld (DE)

(73) Assignee: OPTIMA life science GmbH, Schwäbisch Hall (DE)

(21) Appl. No.: 18/698,278

(22) PCT Filed: Oct. 27, 2022
(86) PCT No.: PCT/EP2022/080142

§ 371 Date: Apr. 3, 2024

(30) Foreign Application Priority Data
Oct. 29, 2021 (DE) 10 2021 212 252.3

(51) Int. Cl. H01M 8/1004; H01M 8/0273

(52) U.S. Cl. CPC H01M 8/1004; H01M 8/0273

(57) ABSTRACT

The invention relates to a method and an apparatus for producing membrane assemblies as roll material, comprising providing a first laminated material (111) as roll material comprising a first frame material (110) and a protective film (112), wherein contour cuts (114) which sever the first frame material (110) are made into the first frame material (110) from a side of the laminated material (111) opposite the protective film (112), with formation of punching residues (116), and wherein the contour cuts (114) are made without severing the protective film (112), and constructing the membrane assembly as roll material, wherein membrane blanks (100) are laminated with the first frame material (110), wherein the first laminated material (111) is transferred to a vacuum transport device (20, 21), wherein, during or after transfer of the first laminated material (111) onto the vacuum transport device (20, 21), the protective film (112) with the punching residues (116) is delaminated from the first frame material (110), and wherein, before or when leaving the vacuum transport device (20, 21), the membrane assembly is laminated with a closed backing sheet (13).

### TECHNICAL FIELD AND PRIOR ART

The invention relates to a method and an apparatus for producing membrane assemblies as roll material.

In one embodiment, the membrane assembly is a membrane electrode assembly (MEA for short) or parts thereof for a fuel cell or an electrolyzer. In one embodiment, an MEA comprises a catalyst-coated membrane (CCM for short), on one side or both sides of which edge reinforcements or frames (rims) composed of relatively inexpensive and relatively resistant material are provided. Such an MEA is also referred to as a 3-layer MEA (3L-MEA for short). For a further structure, two electrodes are applied to outer sides of the 3L-MEA, which electrodes are designed as anode and cathode and in one embodiment are provided in a laminate with two gas diffusion layers (GDL for short). The structure may be produced in a process with the production of the 3L-MEA or in a spatially and/or temporally separate process. In another embodiment, an MEA comprising a membrane and two electrodes arranged thereon is provided, wherein edge reinforcements or frames are applied to one or both sides of this MEA.

Membrane assemblies for other applications, for example for a liquid battery (redox flow battery) or membrane-based air humidifiers, are also known.

DE 10 2020 206 609 A1 discloses a method and an apparatus for producing membrane assemblies as roll material, wherein a laminated material comprising a frame material and a protective film is provided and the protective film is delaminated from the frame material before the frame material is placed on a vacuum conveyor. Blanks of an electrode membrane film are placed on the frame material.

### PROBLEM AND SOLUTION

It is an object to provide a method and an apparatus for producing membrane assemblies as roll material having improved stability.

This object is solved by the subject matter having the features of claims 1 and 9. Advantageous embodiments arise from the dependent claims.

According to a first aspect, a method for producing a membrane assembly as roll material, in particular a membrane electrode assembly is (MEA), provided comprising: providing a first laminated material as roll material comprising a first frame material and a protective film, wherein contour cuts which sever the first frame material are made into the first frame material from a side of the laminated material opposite the protective film, with formation of punching residues, and wherein the contour cuts are made without severing the protective film, and constructing the membrane assembly as roll material, wherein the first laminated material is transferred onto a vacuum transport device, wherein, during or after transfer of the first laminated material onto the vacuum transport device, the protective film with the punching residues is delaminated from the first frame material, and wherein, before or when leaving the vacuum transport device, the membrane assembly is laminated with a closed backing sheet.

In conjunction with the application, the terms “first” and “second” serve merely for differentiation and do not specify a sequence. The term “first” also does not necessarily require the presence of second, structurally identical or similar elements. In conjunction with the application, “a”, “an”, etc. are used merely as an indefinite article and not as numerical values.

In conjunction with the application, a web-like frame material, a web-like protective film, a backing sheet or another web-like material are referred to as material webs. In conjunction with the application, lamination refers to both a temporary and a permanent connecting of material webs. Correspondingly, detachment or separation of the material webs is referred to as delamination.

Before being transferred onto the vacuum transport device, the frame material is stabilized by means of the protective film. After the transfer, the frame material is stabilized by means of the vacuum transport device. order In to ensure sufficient stabilization, provision is made for the protective film to be delaminated from the first frame material only during or after the transfer of the first laminated material onto the vacuum transport device. When leaving the vacuum transport device, the membrane assembly is stabilized by means of the closed backing sheet. In one embodiment, the membrane assembly stabilized by means of the backing sheet is temporarily stored as roll material for locally and/or spatially separate further processing. In other embodiments, immediate further processing is effected in a web-processing installation.

Here, a closed backing sheet refers to a material web which has only insignificant cuts or apertures, if any, and thus a high stability against warpage during processing.

In one embodiment, the vacuum transport device comprises a vacuum transport belt, which is used to effect linear conveying. Alternatively or additionally, the vacuum transport device comprises a vacuum roller in another embodiment.

In one embodiment, the membrane assembly is constructed on the first frame material transferred onto the vacuum transport device. For this purpose, in one embodiment the vacuum transport device comprises at least one vacuum transport belt on which the layers of the membrane assembly can be stacked.

In one embodiment, the membrane blanks are a CCM for an MEA. In other embodiments, the membrane blanks are a membrane with two electrodes.

In embodiments, the contour cuts are made into the first frame material by means of a punching method, in particular by means of punching. rotary In advantageous embodiments, the protective film serves as cutting base. In one embodiment, the contour cuts are made in a common process with a further processing of the laminated material. In other embodiments, the laminated material is prepared temporally and/or spatially separately to a further processing operation.

In one embodiment, the first laminated material with the first frame material is placed directly on the vacuum transport belt. In conjunction with the application, direct placement refers to placement without an interposed backing sheet or an interposed protective film. Direct placement makes it possible to reduce material requirements. In this case, a stabilization of the membrane assembly constructed on the first frame material is ensured by means of the vacuum transport belt and by means of the backing sheet, with which the membrane assembly is laminated before or when leaving the vacuum transport belt.

In one embodiment, the vacuum transport device is operated so as to assist the delamination of the protective film with the punching residues from the first frame material. For this purpose, in one embodiment the vacuum transport device comprises a switching strip which is operated so as to reduce a suction action of the vacuum transport device in a temporary and/or locally limited manner. In one embodiment, the switching strip has nozzles which can be used to blow out a fluid, in particular air, for a reduction of the suction action.

In one embodiment, the method further comprises providing a second web-like laminated material comprising a second frame material and the backing sheet, and placing the second laminated material on the membrane assembly comprising the first frame material and the membrane blanks, wherein the backing sheet is arranged on a side facing away from the first frame material.

In one embodiment, the backing sheet has adhesive properties, wherein, in one embodiment, the backing sheet can be delaminated from the second frame material without leaving residue, and therefore that surface of the second frame material which is exposed by means of the delamination has no adhesive properties. In the other embodiments, the exposed surface is connected to further layers in a further processing operation, and therefore adhesive residues are acceptable.

In one embodiment, the provision of the second laminated material comprises making contour cuts into the second frame material which sever the second frame material. In one embodiment, it is provided in this respect that in the second laminated material, comprising the second frame material and the backing sheet, contour cuts which sever the frame material are made into the second frame material from a side of the laminated material opposite the backing sheet, with formation of punching residues, and the contour cuts are made without severing the backing sheet.

In another embodiment, it is provided that the second frame material is provided on a protective film, wherein contour cuts which sever the second frame material are made into the second frame material from a side opposite the protective film, with formation of punching residues, wherein the contour cuts are made without severing the protective film, wherein the backing sheet is applied to a side of the second frame material opposite the protective film and the protective film is delaminated before the second laminated material comprising the second frame material and the backing sheet is placed on the membrane assembly.

In one embodiment, the backing sheet and a protective film arranged on the second frame material are manufactured in a structurally identical manner or at least from the same material. In other embodiments, the backing sheet and the protective film are manufactured from different materials.

In embodiments, the contour cuts are made into the second frame material by means of a punching method, in particular by of rotary means punching. In advantageous embodiments, the backing sheet serves as cutting base. In one embodiment, the contour cuts are made in a common process with a further processing of the second laminated material. In other embodiments, the second laminated material is prepared temporally and/or spatially separately to a further processing operation.

In an alternative embodiment, the method further comprises providing a second frame material, and placing the second frame material on the membrane assembly comprising the first frame material and the membrane blanks, wherein, after the second frame material has been placed, lamination with the backing sheet is effected. In other words, the backing sheet is in this case applied to the membrane assembly after the second frame material.

Here, the provision of the second frame material comprises making contour cuts which sever the second frame material into the second frame material.

In one embodiment in this case contour cuts which sever the frame material are made into the second frame material, with removal of punching residues. In other words, in this case a protective film and/or a backing sheet for the second frame material are/is omitted. In embodiments, the windows are made into the second frame material by means of a punching method, in particular by means of rotary punching. In one embodiment, the windows are made in a common process with a further processing of the second frame material.

In an alternative embodiment, the second frame material is provided on a protective film, contour cuts which sever the second frame material are made into the second frame material from a side opposite the protective film, with formation of punching residues, wherein the contour cuts are made without severing the protective film, and the protective film is delaminated before the second laminated material is placed on the membrane assembly.

In one embodiment, the method further comprises fixing the membrane assembly comprising the first frame material, the membrane blanks and the second frame material by activation of an adhesive layer provided on the first frame material and/or on the second frame material. In one embodiment, an adhesive layer is applied to the second frame material on a side facing the first frame material directly before lamination. In other embodiments, an adhesive layer which is exposed by the delamination of the protective film is additionally or alternatively provided on the first frame material. In this respect, in one embodiment an adhesive layer which is exposed by the delamination of the protective film is provided exclusively on the first frame material. This makes it possible to dispense with an application of adhesive when processing the material webs. In this case, the second frame material is connected to the membrane blank indirectly by way of the first frame material. In other embodiments, an adhesive layer which is exposed by the delamination of the protective film is also provided on the second frame material.

According to a second aspect, an apparatus for producing a membrane assembly, in particular a membrane electrode assembly (MEA), is provided comprising a first material feed device which is configured to provide a first laminated material as roll material comprising a first frame material and a protective film, wherein contour cuts which sever the first frame material are made into the first frame material from a side of the laminated material opposite the protective film, with formation of punching residues, and wherein the contour cuts are made without severing the protective film, a lamination station which is configured to laminate membrane blanks with the first frame material, and a vacuum transport device, wherein the apparatus is configured to transfer the first laminated material onto the vacuum transport device, wherein the apparatus further comprises a delamination station, arranged on the vacuum transport device, for delamination of the protective film with the punching residues from the first frame material during or after transfer of the first laminated material onto the vacuum transport device, and a lamination station, arranged on the vacuum transport device, for lamination of the membrane assembly with a closed backing sheet before or when leaving the vacuum transport belt.

In one embodiment, the apparatus is configured to transfer the first laminated material with the first frame material directly onto the vacuum transport device.

In one embodiment, the vacuum transport device can be operated so as to assist the delamination of the protective film with the punching residues from the first frame material. For this purpose, in one embodiment the vacuum transport device has a switching strip which can be operated so as to reduce a suction action of the vacuum transport device in a temporary and/or locally limited manner.

In one embodiment of the apparatus, a second material feed device is provided and is configured to provide a second web-like laminated material comprising a second frame material and the backing sheet. In one embodiment, the second material feed device further comprises the lamination station in order to place the second laminated material on the membrane assembly comprising the first frame material and the membrane blanks in such a way that the backing sheet is arranged on a side facing away from the first frame material.

In one embodiment, provision is made in this case for the second material feed device to comprise a punching device for making contour cuts into the second frame material, which sever the second frame material.

In one embodiment, the punching device is configured to make contour cuts into the second frame material, which sever the frame material, wherein the contour cuts are made from a side of the second laminated material opposite the backing sheet, with formation of punching residues, without severing the backing sheet.

In another embodiment, the punching device is configured to make contour cuts into the second frame material, which sever a second frame material provided on a protective film, wherein the contour cuts are made from a side opposite the protective film, with formation of punching residues, without severing the protective film, wherein a backing sheet lamination station which is configured to laminate the backing sheet with the second frame material on a side opposite the protective film is provided on the material feed device and a protective film delamination station which is configured to delaminate the protective film before the second laminated material is placed on the membrane assembly is provided on the material feed device.

In an alternative embodiment, an alternative second material feed device is provided and is configured to provide a second frame material and to place the second frame material on the membrane assembly comprising the first frame material and the membrane blanks, wherein the lamination station for lamination of the membrane assembly comprising the first frame material, the membrane blanks and the second frame material with the backing sheet is provided downstream of the second material feed device.

In one embodiment, the backing sheet is applied to a side of the second frame material facing away from the first frame material. In another embodiment, the backing sheet is applied to a side of the first frame material facing away from the second frame material.

Here, the second material feed device comprises a punching device for making contour cuts into the second frame material, which sever the second frame material.

In one embodiment, the punching device is configured to make contour cuts into the second frame material, which sever the frame material, with removal of punching residues. In this design, the second frame material is processed without a protective film.

In another embodiment, the punching device is configured to make contour cuts into the second frame material, which sever a second frame material provided on a protective film, wherein the contour cuts are made from a side opposite the protective film, with formation of punching residues, without severing the protective film, wherein a protective film delamination station is provided in order to delaminate the protective film before the second laminated material is placed on the membrane assembly.

In one the embodiment, apparatus further comprises a fixing station which is configured to fix the membrane assembly comprising the first frame material, the membrane blanks and the second frame material by activation of an adhesive layer provided on the first frame material and/or on the second frame material. In one embodiment, the fixing station comprises two rollers, wherein the membrane assembly comprising the first frame material, the membrane blanks and the second frame material is guided through between the rollers by means of the backing sheet.

In embodiments in which the second frame material is provided without a protective film, an adhesive layer which can be exposed by the delamination of the protective film is preferably provided exclusively on the first frame material. In this case, the second frame material is connected to the membrane blank indirectly by way of the first frame material.

### BRIEF DESCRIPTION OF THE DRAWINGS

Further advantages and aspects of the invention will become apparent from the claims and from the description of exemplary embodiments of the invention, which are explained below on the basis of the schematic figures, in which:

FIG. 1 shows a membrane assembly comprising a first frame, a second frame and an interposed membrane;

FIG. 2 shows a first embodiment of an apparatus for producing the membrane assembly according to FIG. 1 as roll material;

FIG. 3 shows an apparatus for delaminating a backing sheet from the membrane assembly according to FIG. 1;

FIG. 4 shows a second embodiment of a second membrane feed device for an apparatus similar to FIG. 2;

FIG. 5 shows a third embodiment of a second membrane feed device for an apparatus similar to FIG. 2; and

FIG. 6 shows a fourth embodiment of a second membrane feed device for an apparatus similar to FIG. 2.

### DETAILED DESCRIPTION OF THE EXEMPLARY EMBODIMENTS

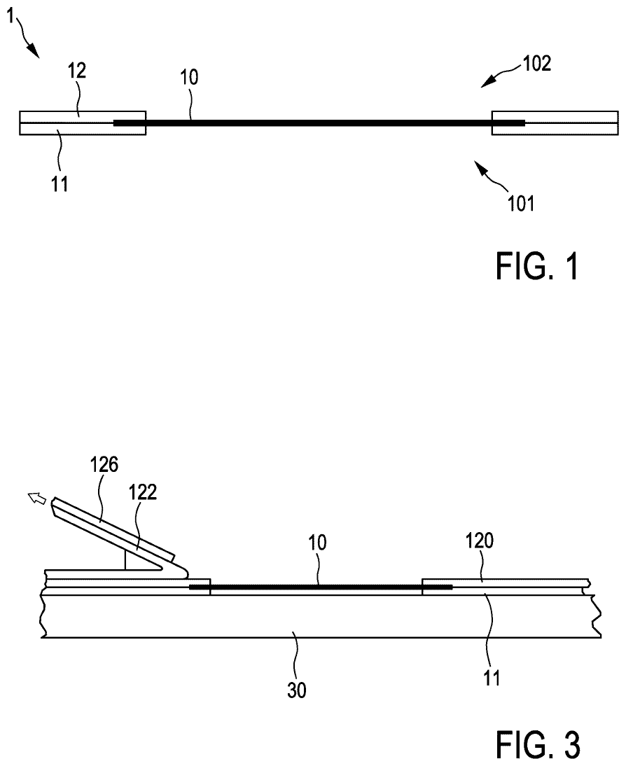

FIG. 1 schematically shows a membrane assembly 1 comprising a first frame 11, a second frame 12 and an interposed membrane 10. The frames 11, 12 surround a functional region of the membrane 10 and preferably fully cover outer edges of the membrane 10. Depending on the embodiment, the frames 11, 12 serve as a connection for further components and/or as a seal of the membrane 10. In conjunction with the application, the cutouts delimited by the frames 11, 12 in the region of the membrane 10 are referred to as windows 101, 102.

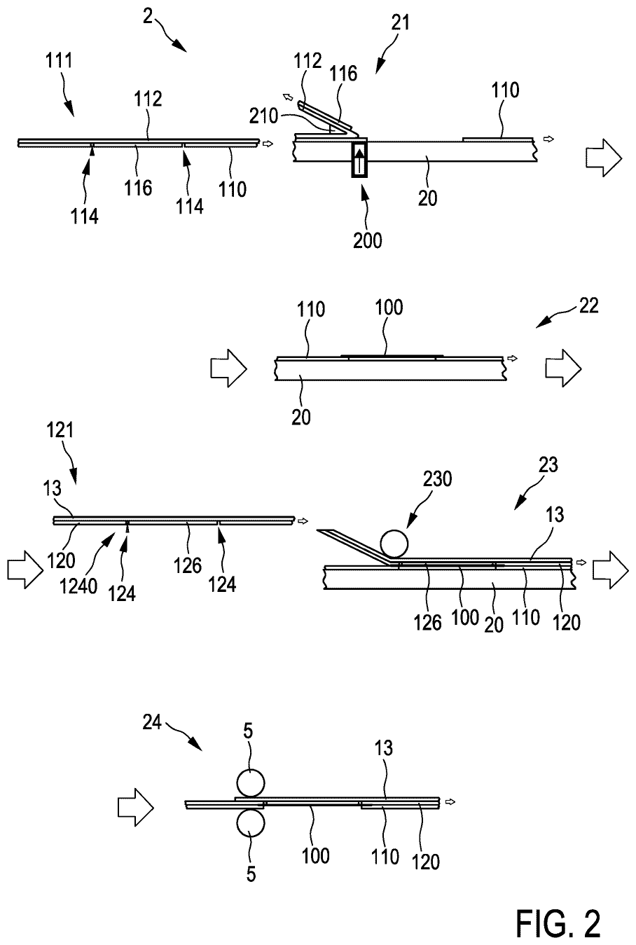

FIG. 2 shows a first exemplary embodiment of an apparatus 2 for producing a membrane assembly according to FIG. 1, wherein, for the frames 11, 12, a first frame material 110 and a second frame material 120 are provided as roll material.

The first web-like frame material 110 for the first frame 11 is provided as a laminated material 111 with a protective film 112. An adhesive layer is applied to one side of the first web-like frame material 110 and is covered by means of the protective film 112. Contour cuts 114 are made into the web-like frame material 110 along inner contours of the first frame 11, wherein the frame material 110 is severed by means of the contour cuts 114, without the protective film 112 being severed. The protective film 112 thus additionally also serves to stabilize the first web-like frame material 110. A punching residue 116 delimited by the contour cut 114 remains on the protective film 112 during delamination of the protective film 112.

The apparatus 2 comprises a vacuum transport device comprising a vacuum transport belt 20, wherein the first laminated material 111 is transferred onto the vacuum transport belt 20. A delamination station 21 is provided on the vacuum transport belt and is used to remove the protective film 112 with the punching residues 116 from the first frame material 110 during or after placing of the laminated material 111. The illustrated delamination station 21 comprises a delamination device 210, such as a delamination roller, a delamination wedge or another deflection element for delamination. A switching strip 200 is provided on the illustrated vacuum transport belt 20 and can be operated so as to reduce a suction action of the vacuum transport belt 20 in a temporary and locally limited manner, in order to thus assist delamination of the punching residue 116 with the protective film 112. For this purpose, in one embodiment the switching strip 200 comprises controllable blowing nozzles.

In one embodiment, the punching residues 116 and the protective film 112 are separated from one another in a subsequent step that is not illustrated, therefore individualized reprocessing of the protective film 112 and of the punching residues 116 in a subsequent recycling process is possible.

The web-like frame material 110 is placed, by way of a side opposite the adhesive layer, directly, i.e. without an interposed backing sheet, on the vacuum transport belt 20, the adhesive layer being exposed after the protective film 112 has been removed.

In a lamination station 22, membrane blanks 100 are then placed on the web-like frame material 110. In one embodiment, placing is effected by a method described in the post-published application DE 102020214263.7 and/or by means of an apparatus described in that application.

In the exemplary embodiment illustrated in FIG. 2, the second frame material 120 is provided on a backing sheet 13 as a laminated material 121 at a second material feed device 23.

The second material feed device 23 illustrated in FIG. 2 comprises a punching device 1240 which is configured to make contour cuts 124 into the second web-like frame material 120 along inner contours of the second frame 12, with the backing sheet 13 not being severed or damaged. The backing sheet 13 thus serves to stabilize the second web-like frame material 120. In the illustrated exemplary embodiment, a punching residue 126 delimited by the contour cut 124 remains on the backing sheet 13.

The second material feed device 23 illustrated in FIG. 2 is configured to place the second laminated material 121, by way of a side opposite the backing sheet 13, on a membrane assembly comprising the first frame material 110 and the membrane blanks 100. For this purpose, the second material feed device 23 comprises a lamination station 230 which is used to laminate the second laminated material 121 comprising the backing sheet 13 with the membrane assembly comprising the first frame material 110 and the membrane blanks 100. In this case, the second frame material 120 is placed together with the backing sheet 13, such that the backing sheet 13 stabilizes a membrane assembly comprising the first frame material 110, the membrane blanks 100 and the second frame material 120. In the illustrated exemplary embodiment, the punching residues 126 of the second frame material 120 are arranged between the membrane blanks 100 and the backing sheet 13, and therefore the membrane blanks 100 are protected in relation to the backing sheet 13.

The membrane assembly which is stabilized by means of the backing sheet 13 and is in the form of roll material can subsequently be removed from the vacuum transport belt 20 and be fed, for example, to a fixing station 24 in which the adhesive layer provided on the first frame material 110 is cured in order to fix the membrane assembly comprising the first frame material 110, the membrane blanks 100 and the second frame material 120. In one embodiment, curing is effected under pressure by means of schematically illustrated pressure rollers 5. Depending on the application, thermal curing and/or radiation curing of the adhesive layer is alternatively or additionally effected. The membrane assembly is in this case guided between the pressure rollers 5 by means of the backing sheet 13.

In the exemplary embodiment illustrated in FIG. 2, no adhesive layer is provided on a side of the second frame material 120 facing the membrane blanks 100. In this case, the second frame material 120 is connected to the membrane blanks 100 indirectly by means of the first frame material 110. In other embodiments, an adhesive is applied to the frame material 120 at the material feed device 23 before the second frame material 120 is placed.

The web-like laminated material stabilized by means of the backing sheet 13 can subsequently be fed to a web-processing installation for further processing. As schematically illustrated in FIG. 3, for further processing, the backing sheet 13 including the punching residues 126 of the second frame material 120 is removed from the membrane assembly. In the illustrated exemplary embodiment, the membrane assembly is arranged on a vacuum transport belt 30 again for stabilization.

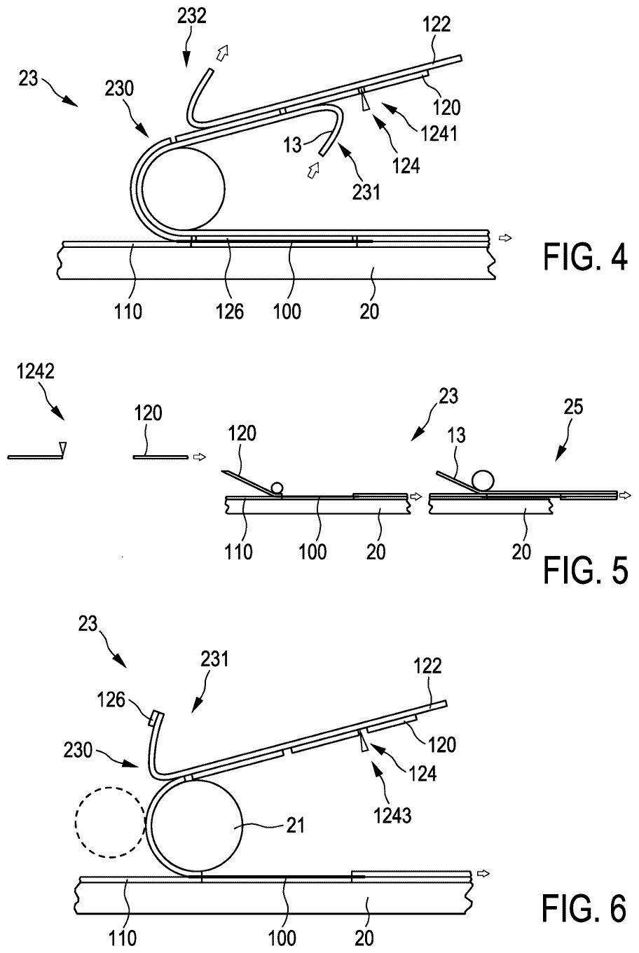

FIG. 4 shows an alternative design of a second material feed device 23 comprising a lamination station 230 for an apparatus 2 for producing a membrane assembly similar to the apparatus according to FIG. 2.

In contrast to the exemplary embodiment according to FIG. 2, in the material feed device 23 according to FIG. 4, the second frame material 120 is provided on a protective film 122. In this case, the material feed device 23 comprises a punching device 1241, a backing sheet lamination station 231 a protective film delamination station 232.

Here, the punching device 1241 is used to make contour cuts 124 into the second frame material 120 from a side opposite the protective film 122, which contour cuts 124 sever the second frame material 120, with formation of punching residues 126, without severing the protective film 122. After the contour cuts 124 have been made, the backing sheet 13 is applied to a side of the second frame material 120 opposite the protective film 122 by means of the backing sheet lamination station 231.

Before the second laminated material 112 comprising the frame material 120 and the backing sheet 13 is placed on the membrane assembly, the protective film 122 is delaminated by means of the protective film delamination station 232.

The backing sheet 13, together with the frame material 120, is laminated with the membrane assembly comprising the first frame material 110 and the membrane blanks 100 by means of the lamination station 230.

In the illustrated exemplary embodiment, the punching residues 126 remain on the backing sheet 13.

In an alternative embodiment, the punching residues 126 are removed with the protective film 122. In one embodiment, an adhesive layer is applied to the second frame material 120 on a side facing away from the backing sheet 13 and is covered by the protective film 122 prior to its delamination.

FIG. 5 shows a further alternative design of a second material feed device 23 for an apparatus 2 for producing a membrane assembly similar to the apparatus according to FIG. 2.

In contrast to the exemplary embodiments according to FIGS. 2 and 4, in the material feed device 23 according to FIG. 5, the second frame material 120 is provided without a backing sheet or a protective film.

The illustrated material feed device 23 comprises a punching device 1242 which is configured to make contour cuts 124 which sever the frame material 120 into the second frame material 120, with removal of punching residues.

The second frame material 120 is applied to the membrane 10 and the first frame material 110 at the material feed device 23.

In order to ensure sufficient stabilization of the thus produced membrane assembly when the latter leaves the vacuum transport belt 20, a lamination station 25 is provided in this case, at which a backing sheet 13 is laminated with the membrane assembly comprising the first frame material 110, the membrane blanks 100 and the second frame material 120.

The membrane assembly stabilized by means of the backing sheet 13 can subsequently be fed to the fixing station 24 comprising the pressure rollers 5.

In one embodiment, further stations, at which further layers are applied to the membrane assembly, are provided between the material feed device 23 and the lamination station 25.

FIG. 6 shows a further alternative design of a second material feed device 23 similar to FIG. 5.

In the material feed device 23 according to FIG. 6, the second frame material 120 is provided without a backing sheet on a protective film 122. The material feed device 23 according to FIG. 6 comprises a punching device 1243 in order to make contour cuts 124 which sever the second frame material 120 provided on the protective film 122 into the frame material 120 from a side opposite the protective film 122, with formation of punching residues 126, without severing the protective film 122.

At the material feed device 23, the second frame material 120 is transferred onto a vacuum roller 21, with delamination of the protective film 122 by means of a delamination protective film station 231. In the illustrated exemplary embodiment, the punching residues 126 are removed with the protective film 122. In one embodiment, an adhesive layer is applied to the second frame material 120 on a side facing the protective film 122 and is covered by the protective film 122 prior to its delamination.

The second frame material 120 is applied to the membrane 10 and the first frame material 110.

In order to ensure sufficient stabilization of the thus produced membrane assembly when the latter leaves the vacuum transport belt 20, a lamination station 25 according to FIG. 5, at which a backing sheet 13 is applied to the membrane assembly comprising the first frame material 110, the membrane blanks 100 and the second frame material 120, is in this case provided downstream of the material feed device 23.

As is apparent in particular in the design according to FIG. 6, in conjunction with the application, the terms “first” and “second” serve merely for differentiation and do not specify a sequence. In an alternative embodiment, the frame material 120 fed via the vacuum roller 21 can be referred to as first frame material, wherein membrane blanks 100 are laminated, as schematically illustrated by a roller in dashed-line form, with the frame material 120 at the vacuum roller 21 and the thus produced laminated material is connected to the frame material 110 arranged on the vacuum transport belt 20.

In this case, the vacuum transport device comprises the vacuum roller 21 and the vacuum transport belt 20. In another embodiment, the vacuum transport device comprises two vacuum rollers.

1. A method for producing a membrane assembly as roll material, comprising:
providing a first laminated material as roll material comprising a first frame material and a protective film, wherein contour cuts which sever the first frame material are made into the first frame material from a side of the laminated material opposite the protective film, with formation of punching residues, and wherein the contour cuts are made without severing the protective film, and
constructing the membrane assembly as roll material, wherein membrane blanks are laminated with the first frame material,
wherein the first laminated material is transferred onto a vacuum transport device,
wherein, during or after transfer of the first laminated material onto the vacuum transport device, the protective film with the punching residues is delaminated from the first frame material, and, before or when leaving the vacuum transport device, the membrane assembly is laminated with a closed backing sheet.

2. The method as claimed in claim 1, wherein the first laminated material with the first frame material is transferred directly onto the vacuum transport device.

3. The method as claimed in claim 1, wherein the vacuum transport device is operated so as to assist the delamination of the protective film with the punching residues from the first frame material.

4. The method as claimed in claim 1, wherein the method further comprises:
providing a second web-like laminated material comprising a second frame material and the backing sheet, and placing the second laminated material on the membrane assembly comprising the first frame material and the membrane blanks, wherein the backing sheet is arranged on a side facing away from the first frame material.

5. The method as claimed in claim 4, wherein the provision of the second laminated material comprises making contour cuts into the second frame material, which contour cuts sever the second frame material, wherein
(a) in the second laminated material comprising the second frame material and the backing sheet contour cuts which sever the frame material are made into the second frame material from a side of the laminated material opposite the backing sheet, with formation of punching residues, and wherein the contour cuts are made without severing the backing sheet, or
(b) the second frame material is provided on a protective film, wherein contour cuts which sever the second frame material are made into the second frame material from a side opposite the protective film, with formation of punching residues, wherein the contour cuts are made without severing the protective film, the backing sheet is applied to a side of the second frame material opposite the protective film and the protective film is delaminated before the second laminated material is placed on the membrane assembly.

6. The method as claimed in claim 1, wherein the method further comprises: providing a second frame material, and placing the second frame material on the membrane assembly comprising the first frame material and the membrane blanks, wherein, after the second frame material has been placed, lamination with the backing sheet is effected.

7. The method as claimed in claim 6, wherein the provision of the second frame material comprises making contour cuts into the second frame material, which contour cuts sever the second frame material, wherein
(a) contour cuts which sever the frame material are made into the second frame material, with removal of punching residues, or
(b) the second frame material is provided on a protective film, wherein contour cuts which sever the second frame material are made into the second frame material from a side opposite the protective film, with formation of punching residues, wherein the contour cuts are made without severing the protective film, and the protective film is delaminated before the second laminated material is placed on the membrane assembly.

8. The method as claimed in claim 4, wherein the membrane assembly comprising the first frame material, the membrane blanks and the second frame material is fixed by activation of an adhesive layer provided on the first frame material and/or on the second frame material.

9. An apparatus for producing a membrane assembly, comprising:
a first material feed device which is configured to provide a first laminated material as roll material comprising a first frame material and a protective film, wherein contour cuts which sever the first frame material are made into the first frame material from a side of the laminated material opposite the protective film, with formation of punching residues, and wherein the contour cuts are made without severing the protective film,
a lamination station which is configured to laminate membrane blanks with the first frame material so as to construct the membrane assembly, and
a vacuum transport device, wherein the apparatus is configured to transfer the first laminated material onto the vacuum transport device,
wherein a delamination station for delamination of the protective film with the punching residues from the first frame material during or after transfer of the first laminated material onto the vacuum transport device is provided on the vacuum transport device, and a lamination station for lamination of the membrane assembly with a closed backing sheet before or when leaving the vacuum transport device is provided on the vacuum transport device.

10. The apparatus as claimed in claim 9, wherein the apparatus is configured to transfer the first laminated material with the first frame material directly onto the vacuum transport device.

11. The apparatus as claimed in claim 9, wherein the vacuum transport device can be operated so as to assist the delamination of the protective film with the punching residues from the first frame material.

12. The apparatus as claimed in claim 9, wherein a second material feed device is provided and is configured to provide a second web-like laminated material comprising a second frame material and the backing sheet, wherein the second material feed device comprises the lamination station in order to laminate the second laminated material with the membrane assembly comprising the first frame material and the membrane blanks, wherein the backing sheet is arranged on a side facing away from the first frame material.

13. The apparatus as claimed in claim 12, wherein the second material feed device comprises a punching device for making contour cuts into the second frame material, which contour cuts sever the second frame material, wherein (a) the punching device is configured to make contour cuts which sever the frame material into the second frame material from a side of the second laminated material opposite the backing sheet, with formation of punching residues, without severing the backing sheet, or (b) the punching device is configured to make contour cuts which sever a second frame material provided on a protective film into the second frame material from a side opposite the protective film, with formation of punching residues, without severing the protective film, wherein a backing sheet lamination station which is configured to laminate the backing sheet with the second frame material on a side opposite the protective film and a protective film delamination station which is configured to delaminate the protective film before the second laminated material is placed on the membrane assembly are provided on the material feed device.

14. The apparatus as claimed in claim 9, wherein a second material feed device is provided and is configured to provide a second frame material and to place the second frame material on the membrane assembly comprising the first frame material and the membrane blanks, wherein the lamination station for lamination of the membrane assembly comprising the first frame material, the membrane blanks and the second frame material with the backing sheet is provided downstream of the second material feed device.

15. The apparatus as claimed in claim 14, wherein the second material feed device comprises a punching device for making contour cuts into the second frame material, which contour cuts sever the second frame material, wherein (a) the punching device is configured to make contour cuts which sever the frame material into the second frame material, with removal of punching residues, or (b) the punching device is configured to make contour cuts which sever a second frame material provided on a protective film into the second frame material from a side opposite the protective film, with formation of punching residues, without severing the protective film, and a protective film delamination station is provided in order to delaminate the protective film before the second laminated material is placed on the membrane assembly.

16. The apparatus as claimed in claim 9, wherein a fixing station is provided and is configured to fix the membrane assembly comprising the first frame material, the membrane blanks and the second frame material by activation of an adhesive layer provided on the first frame material and/or on the second frame material.

17. The method as claimed in claim 1, wherein the membrane assembly comprises a membrane electrode assembly (MEA).

18. The method as claimed in claim 3, wherein the vacuum transport device has a switching strip which is operated so as to reduce a suction action of the vacuum transport device in a temporary and/or locally limited manner.

19. The method as claimed in claim 8, wherein an adhesive layer which is exposed by the delamination of the protective film is provided on the first frame material.

20. The apparatus as claimed in claim 9, wherein the membrane assembly comprises a membrane electrode assembly (MEA).
